(19) United States
(12) Patent Application Publication
(10) Pub. No.: US 2025/0077522 A1
(43) Pub. Date: Mar. 6, 2025

(54) Intelligent Query Routing based on Query Storage Cost for Tiered Databases

(71) Applicant: ZettaBlock, Inc, San Francisco, CA (US)

(72) Inventors: Rohit Shekhar, San Francisco, CA (US); Chi Zhang, San Francisco, CA (US); Ruisheng Shi, San Francisco, CA (US)

(73) Assignee: ZettaBlock, Inc, San Francisco, CA (US)

(21) Appl. No.: 18/821,721

(22) Filed: Aug. 30, 2024

Related U.S. Application Data
(60) Provisional application No. 63/579,755, filed on Aug. 30, 2023.

(51) Int. Cl. G06F 16/2453; G06F 11/34; G06F 16/28

(52) U.S. Cl. CPC G06F 16/24545; G06F 11/3419; G06F 16/283

(57) ABSTRACT

Systems and methods for optimizing database routing in accordance with embodiments of the invention are illustrated. One embodiment includes a tiered database. The tiered database includes a data warehouse used to store obtained data. The tiered database includes a relational layer that stores a copy of a subset of the obtained data within a certain period of recency. The tiered database includes a query planner. The query planner is configured to receive a new query and determine a query plan to respond to the query. The query planner is configured to compute, from a set of database metrics and the preliminary query plan, a storage access cost. The query planner is configured to route the query based on the storage access cost, wherein the query is routed: to the data warehouse when the storage access cost exceeds a predetermined threshold; and to the relational layer otherwise.

### CROSS-REFERENCE TO RELATED APPLICATIONS

The current application claims the benefit of and priority under 35 U.S.C. § 119 (e) to U.S. Provisional Patent Application No. 63/579,755 entitled “Intelligent Query Routing based on Query Storage Cost for Tiered Databases,” filed Aug. 30, 2023. The disclosure of U.S. Provisional Patent Application No. 63/579,755 is hereby incorporated by reference in its entirety for all purposes.

### FIELD OF THE INVENTION

The present invention generally relates to database query management and, more specifically, database configurations for facilitating automatic query routing.

### BACKGROUND

Relational databases are collections of information that organize data points with defined relationships for easy access, typically over sets of multiple databases that can be combined in various ways. Relational database management systems (RDBMSs) are typically implemented as software programs that manage the storage and access to data, and are generally configured to utilize Structured Query Language (SQL) for querying, managing, and modifying relational databases.

SQL primarily operates off enabling queries, which are requests for information from database tables, where the outputs (known as views) represent snapshots (i.e., copies) of the relevant subsets of the already-established “base tables.” In many cases, views can be obtained through combining (or joining) multiple base tables to allow the derived views to display fields from the base tables. The underlying databases utilized in an RDBMS configuration can also vary in form.

In contrast to standard databases, a data lake is typically implemented as a storage repository that is designed to store, process, and secure large amounts of structured, semi-structured, and unstructured data. The centralized configuration of a data lake allows them to receive content from a number of data sources simultaneously. Further, data lake content tends to be in raw/unprocessed form, and storage of data within a data lake doesn't carry the requirement of transforming the content in order to ease storage. As a result, data for which analysis isn't particularly time-sensitive tends to be stored in data lakes to minimize cost, with analysis and processing performed later.

A similar mode of data storage is a data warehouse: which is typically a storage repository that tends to be used for structured data with an immediately known purpose such as analytics. Like data lakes, data warehouses can store large amounts of current and historical data from a wide variety of sources. As a result, Extract, Transform, Load (ETL) and/or Extract, Load, Transform (ELT) methods may be used to extract the relevant raw data from their disparate sources; transform, process, and/or restructure the extracted data in order to comply with data warehouse configurations; and upload the transformed data.

Data storage also is sometimes facilitated through having different storage repositories fulfill different functions, minimizing processing time. The use of tiered databases offers the ability to place data on optimal tiers to maximize efficiency. Data caching is used to store originals or copies of frequently-queried data in temporary memory for ease of access.

Like data storage, data processing can similarly take various forms in addition to ETL and ELT methods. For example, in real-time databases, data may be processed on an immediate and continuous basis in order to facilitate storage. Alternatively, databases may be configured to process raw data all at once in batches.

### SUMMARY OF THE INVENTION

Systems and methods for optimizing database routing in accordance with embodiments of the invention are illustrated. One embodiment includes a tiered database. The tiered database includes a data warehouse that is configured to store obtained data. The tiered database includes a relational layer wherein: the relational layer stores a copy of a subset of the obtained data, and the subset of the obtained data includes entries stored in the data warehouse within a certain period of recency. The tiered database further includes a proxy layer. The proxy layer includes a collection of relational metadata including a set of database metrics for a tiered database, wherein the set of database metrics is derived from the obtained data. The tiered database includes a query planner. The query planner is configured to receive a new database query and determine a preliminary query plan to respond to the database query. The query planner is configured to compute, from the set of database metrics and the preliminary query plan, a storage access cost. The query planner is configured to route the database query based on the storage access cost, wherein the query is routed: to the data warehouse when the storage access cost exceeds a predetermined threshold; and to the relational layer when the storage access cost does not exceed the predetermined threshold. The query planner is configured to receive a result to the database query from at least one of the data warehouse or the relational layer. The query planner is configured to return the result to the database query to the sender.

In a further embodiment, the data warehouse includes: a lakehouse architecture, wherein the lakehouse architecture accesses a data storage entity for unstructured data, processes the unstructured data, and stores the processed data in the data warehouse; at least one data manipulation language (DML) operation; and a slowly changing dimension (SCD), wherein the SCD maintains entries to the data warehouse, updates the entries, and tracks frequencies of updates for the entries.

In another embodiment, the set of database metrics includes: a first set of database metrics corresponding to the data warehouse; and a second set of database metrics corresponding to the relational layer. Computing, from the set of database metrics and the preliminary query plan, the storage access cost, includes computing a first storage access cost from the first set of database metrics and the preliminary query plan, wherein the first cost is in a first unit of measurement; computing a second cost from the second set of database metrics and the preliminary query plan, wherein the second cost is in a second unit of measurement; and converting the first and second costs into the storage access cost, wherein the storage access cost is in a third unit of measurement.

In still another embodiment, the preliminary query plan follows a tree graph structure comprising a plurality of nodes; each node of the plurality of nodes corresponds to a SQL operation; and nodes at a bottom level of the tree graph structure are configured to return raw rows from the subset of the obtained data.

In a further embodiment, the result to the database query includes a materialized view; and the query planner is further configured to store the result to the database query in the relational layer.

In yet another embodiment, a database metric of the set of database metrics is selected from the group including: a metadata metric, a schema detail, a table statistic, an index statistic, and a system statistic. The database metric is obtained from an external database ingestor, wherein the external database ingestor utilizes a tree graph structure for computational logic. The database metric is cached on the proxy layer, wherein the set of database metrics is updated on the proxy layer at a set duration.

One embodiment includes a method for operating a query planner. The method receives a database query made to a tiered database. The tiered database includes a data warehouse, a proxy layer, and a relational layer. The database query corresponds to obtained data stored in the data warehouse. The method determines a preliminary query plan to respond to the database query. The method recovers, from a collection of relational metadata stored in the proxy layer, a set of database metrics, for the tiered database, derived from the obtained data. The method computes, from the set of database metrics and the preliminary query plan, a storage access cost, wherein the storage access cost includes an estimate for time required to respond to the database query. The method routes the database query based on the storage access cost. The database query is routed to the data warehouse when the storage access cost exceeds a predetermined threshold. The database query is routed to the relational layer when the storage access cost does not exceed the predetermined threshold, where: the relational layer stores a copy of a subset of the obtained data. The subset of the obtained data includes entries stored in the data warehouse within a certain period of recency. The process receives a result to the database query from at least one of the data warehouse or the relational layer. The process returns the result to the database query to the sender.

In a further embodiment, the data warehouse includes: a lakehouse architecture, wherein the lakehouse architecture accesses a data storage entity for unstructured data, processes the unstructured data, and stores the processed data in the data warehouse; at least one data manipulation language (DML) operation; and a slowly changing dimension (SCD), wherein the SCD maintains entries to the data warehouse, updates the entries, and tracks frequencies of updates for the entries.

In another embodiment, the set of database metrics includes: a first set of database metrics corresponding to the data warehouse; and a second set of database metrics corresponding to the relational layer. Computing, from the set of database metrics and the preliminary query plan, the storage access cost, includes computing a first storage access cost from the first set of database metrics and the preliminary query plan, wherein the first cost is in a first unit of measurement; computing a second cost from the second set of database metrics and the preliminary query plan, wherein the second cost is in a second unit of measurement; and converting the first and second costs into the storage access cost, wherein the storage access cost is in a third unit of measurement.

In still another embodiment, the preliminary query plan follows a tree graph structure comprising a plurality of nodes; each node of the plurality of nodes corresponds to a SQL operation; and nodes at a bottom level of the tree graph structure are configured to return raw rows from the subset of the obtained data.

In a further embodiment, the result to the database query includes a materialized view; and the method stores the result to the database query in the relational layer.

In yet another embodiment, a database metric of the set of database metrics is selected from the group including: a metadata metric, a schema detail, a table statistic, an index statistic, and a system statistic. The database metric is obtained from an external database ingestor, wherein the external database ingestor utilizes a tree graph structure for computational logic. The database metric is cached on the proxy layer, wherein the set of database metrics is updated on the proxy layer at a set duration.

One embodiment includes a non-transitory computer-readable medium including instructions that, when executed, are configured to cause a processor to perform a process for operating a query planner. The process receives a database query made to a tiered database. The tiered database includes a data warehouse, a proxy layer, and a relational layer. The database query corresponds to obtained data stored in the data warehouse. The process determines a preliminary query plan to respond to the database query. The process recovers, from a collection of relational metadata stored in the proxy layer, a set of database metrics, for the tiered database, derived from the obtained data. The process computes, from the set of database metrics and the preliminary query plan, a storage access cost, wherein the storage access cost includes an estimate for time required to respond to the database query. The process routes the database query based on the storage access cost. The database query is routed to the data warehouse when the storage access cost exceeds a predetermined threshold. The database query is routed to the relational layer when the storage access cost does not exceed the predetermined threshold, where: the relational layer stores a copy of a subset of the obtained data. The subset of the obtained data includes entries stored in the data warehouse within a certain period of recency. The process receives a result to the database query from at least one of the data warehouse or the relational layer. The process returns the result to the database query to the sender.

In a further embodiment, the data warehouse includes: a lakehouse architecture, wherein the lakehouse architecture accesses a data storage entity for unstructured data, processes the unstructured data, and stores the processed data in the data warehouse; at least one data manipulation language (DML) operation; and a slowly changing dimension (SCD), wherein the SCD maintains entries to the data warehouse, updates the entries, and tracks frequencies of updates for the entries.

In another embodiment, the set of database metrics includes: a first set of database metrics corresponding to the data warehouse; and a second set of database metrics corresponding to the relational layer. Computing, from the set of database metrics and the preliminary query plan, the storage access cost, includes computing a first storage access cost from the first set of database metrics and the preliminary query plan, wherein the first cost is in a first unit of measurement; computing a second cost from the second set of database metrics and the preliminary query plan, wherein the second cost is in a second unit of measurement; and converting the first and second costs into the storage access cost, wherein the storage access cost is in a third unit of measurement.

In still another embodiment, the preliminary query plan follows a tree graph structure comprising a plurality of nodes; each node of the plurality of nodes corresponds to a SQL operation; and nodes at a bottom level of the tree graph structure are configured to return raw rows from the subset of the obtained data.

In a further embodiment, the result to the database query includes a materialized view; and the process stores the result to the database query in the relational layer.

In yet another embodiment, a database metric of the set of database metrics is selected from the group including: a metadata metric, a schema detail, a table statistic, an index statistic, and a system statistic. The database metric is obtained from an external database ingestor, wherein the external database ingestor utilizes a tree graph structure for computational logic. The database metric is cached on the proxy layer, wherein the set of database metrics is updated on the proxy layer at a set duration.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 illustrates a process for routing database queries in accordance with many embodiments of the invention.

FIGS. 2A-2B conceptually illustrate a tiered database configured in accordance with numerous embodiments of the invention.

FIGS. 3-4 illustrate a system that provides for facilitation of tiered databases in accordance with certain embodiments of the invention.

### DETAILED DESCRIPTION

Turning now to the drawings, tiered database systems configured in accordance with many embodiments of the invention are illustrated. Tiered database systems, configured in accordance with a number of embodiments of the invention, may incorporate functionality enabling automated routing of database queries to at least one of a plurality of database layers (also referred to as database tiers in this disclosure). Automated routing may be performed based on attributes including but not limited to the estimated processing power and/or the cost associated with responding to the query through individual database tiers.

The plurality of tiers implemented within tiered databases may include but are not limited to real-time databases, data lakes, and/or proxy layers. Such databases may be configured to enable database transactions and/or changes that have properties known as ACID properties. ACID properties refer to atomicity (i.e. updates happening in their entirety and not being cut off); consistency (i.e. adhering to database rules); isolation (i.e. changes are initiated concurrently), and/or durability (i.e., database permanence in the face of system crashes). In addition, database transactions and/or changes within tiered databases implemented in accordance with various embodiments of the invention can be serialized and performed on an individual basis.

Systems and methods configured in accordance with numerous embodiments of the invention may combine efficient query planning and index utilization, with the capacity for parallel processing of colossal datasets. Specifically, database statistics and schema characteristics may be utilized to summarize the structure and characteristics of stored data. Analysis of these characteristics, including but not limited to unique values, histograms, and distribution, systems may refine routing configurations in order to maximize efficiency. Systems configured in accordance with some embodiments may prioritize storage costs. Additionally or alternatively, scaling concerns including but not limited to CPU and memory can be addressed through replication-based scaling. This deliberate focus simplifies query router analysis, yielding more accurate routing decisions. Systems may be configured for generating query plans centered on predicting the storage cost associated with database queries. Capitalizing on append-only workloads prevalent in the database, systems can perform real-time computations and caching of statistics, updating routing configurations accordingly.

The databases utilized by systems, operating in accordance with numerous embodiments of the invention, may be based on configurations including but not limited to Postgres (also referred to as PostgreSQL in this disclosure). PostgreSQL, or Postgres, is an open-source object-relational database management system (RDBMS) intended to prioritize extensibility. Within PostgreSQL, data stored in base tables (also referred to as “relations”) may be managed and/or accessed. As such, the PostgreSQL system is configured to perform a substantial number of SQL functions, in addition to incorporating unique operations. PostgreSQL functionality includes but is not limited to the capacity for automatically updatable views, allowing views resulting from queries to automatically update upon notification that the data serving that view has been updated. Further, PostgreSQL provides for the creation of materialized views. Specifically, certain views obtained from base tables may be materialized in order to enable users to access them quickly and easily. A materialized view is typically considered to be a database object that contains the results of a query. In being materialized, these views may be pre-computed, stored/cached as concrete views, and/or updated. Materialized views typically operate under the assumption that the views will need to be accessed on a frequent basis. The updating of views and other database items, as performed by PostgreSQL can be initiated through “triggers” that execute the updates in response to particular transactions and/or interactions. PostgreSQL carries the ability to rewind databases to earlier states (“change data capture”) in the case of significant errors.

PostgreSQL includes additional unique functionality for handling queries. PostgreSQL devises a query plan for each query it receives in the form of a tree of nodes. Nodes at the bottom level of the tree are configured to return raw rows from base table(s). Nodes at higher levels may apply additional operations and/or conditions to the raw rows. Potential operations include but are not limited to sequential scans (Seq Scan) that sequentially scan the rows of the entire base table(s) to see what matches the query; index scans that perform searches by searching for specific data entries with indices matching the query; materializations (Materialize) that output materialized views; filtering (Filter) that outputs entries according to specific entries with specific fields that match the query; limiting (Limit) that limits the number of entries (also referred to as rows or tuples) in a view; joining (Join) that combines fields from multiple tables by using values common to each; and Join Filters that perform Filter operations prior to performing Join operations.

In the below example, a query plan is applied to two base tables: “d”, referring to a base table of departments; and “e”, referring to a base table of employees. Under a system configured in accordance with some embodiments of the invention and utilizing PostgreSQL, the resulting query plan may take the following form:
Nested Loop (cost=50.00 . . . 100.00 rows=10 width=64)
Join Filter: (e.department=d.department_name)
->Seq Scan on departments d (cost=0.00 . . . 20.00 rows=2 width=64)
   Filter: (location=‘New York’::text)
->Materialize (cost=50.00 . . . 100.00 rows=10 width=64)
   Seq Scan on employee e (cost=0.00 . . . 20.00 rows=10 width=64)
      Filter: age>=30).

The above query plan corresponds to a query for employees of a New York organization branch and/or employees that are at least 30 years old. The query plan is performed in a nested loop: based on two loops through the data set. In the query plan, the nested loop indicates that a first scan is performed for an outer table (d), and a second scan is performed for the joined table including the filtered portion of the outer table and the (subsequently) joined portions of the inner table (e). In such cases, the first loop represents a scan through all the rows of the first set (d) for entries meeting the condition (d.location=‘New York’). Subsequently, a join operation is performed where the resulting materialized view includes all the entries for d where a corresponding e.department_name exists OR where (d.location=‘New York’). Finally, a second loop is performed for the materialized view to filter all the entries where (e.age>=30). As such, by performing the above query plan, a materialized view can be produced for employees that are part of the New York organization branch and/or are at least 30 years old.

Further, for the nested loop, the query plan discloses a set of variable estimates including the startup cost (50.00) corresponding to an estimated cost of starting the operation (i.e., of returning the first row); the total cost (100.00) corresponding to an estimated cost of performing the full operation(s); the plan rows (10) representing a number of rows estimated to be part of the operation output, and the plan width (64) representing an estimated number of fields in the operation output. The same estimates are made for the sequential scan of d, the materialized view based on the filtered entries, and the sequential scan of the joined tables.

Materialized views in PostgreSQL use the rule system like views do, but the results take a table-like form. The queries used to create the materialized view are stored in exactly the same way that a view's query is stored, so that fresh data can be generated for the materialized view, and the materialized views can be refreshed (e.g., using a REFRESH function call). The information about a materialized view in PostgreSQL system catalogs is exactly the same as for a table or view. So when a materialized view is referenced in a query, the data is returned directly from the materialized view, like from a table; the rule is only used for populating the materialized view.

Additionally or alternatively, data warehouses utilized by systems operating in accordance with various embodiments of the invention may be based on configurations following Lakehouse architectures, including but not limited to Delta Lake. Delta Lake is an open-source storage (and processing) layer maintained by the Linux Foundation, which is designed to run on top of an existing data lake(s) and improve reliability, security, and performance (also referred to as a “lakehouse” architecture). Delta Lake incorporates changes made to the incoming data in serialized transaction logs, using the logs to increase reliability, facilitate audits, and enable users to precisely recreate the previous states of datasets, views, and/or data analyses. Incoming unstructured data can be stored on the data lake “layer,” processed, and transferred to the data warehouse layer. Further, Delta Lake supports data manipulation language (DML) operations including but not limited to merge, update, and delete commands. In addition to change data capture methods, this functionality allows complex use cases including but not limited to streaming upserts (update database/data lake fields with values from the incoming stream when the corresponding fields already exist; add new fields for the values from the incoming stream when they do not already exist) and/or slowly changing dimension (SCD) operations (that store and manage both current and historical data over time).

Query latency can be a significant problem when querying large and/or distributed data sources. Many systems attempt to address query latency using caching. For example, many systems utilize a NoSQL database (e.g. the Redis open source software NoSQL database) in combination with a Content Distribution Network. These systems often rely upon a restricted set of simple queries and data types, and a set of caching policies to retrieve data from local cache servers. In accordance with many embodiments of the invention, tiered database architectures, amalgamations of RDBMSs, and data warehouses may be collectively applied for query optimization. Specifically, RDBMS configurations are most effectively used with queries that can capitalize on the relational structure, utilizing indexes and query plans effectively. Additionally or alternatively, data warehouses are most effectively used with queries demanding extensive data scans and parallel processing; in doing so, they may overcome the limitations posed by large-scale data handling.

Ensuring the efficiency of RDBMSs in the area of query routing can lie in prudently circumventing storage bottlenecks stemming from query-driven storage demands. Despite the scalability of CPU and memory via replication-based solutions, the conundrum of routing decisions persists due to reasons including that: crafting an optimized query plan is intricate, necessitating a deep understanding of database nuances; and query planning heavily relies on real-time database statistics, which can be difficult to extract from external layers.

Systems configured in accordance with numerous embodiments of the invention may address the above concerns by harnessing the potential of database statistics and schema characteristics. Utilizing schema characteristics, by considering factors including but not limited to row count and size, may allow systems to glean valuable insights into the structure of the data. Additionally or alternatively, through the analysis of column characteristics including but not limited to unique values, histograms, and distribution, systems may derive comprehensive views of the nature of the data.

Systems and methods in accordance with various embodiments may generate (and/or update preliminary) query plans using operations centered on predicting the storage cost associated with database queries. Capitalizing on the append-only workload prevalent in the database, systems may perform real-time computations and cache statistics from database ingestors. This may eliminate the need to rely on the database for collecting the most up-to-date statistics.

These statistics can form the cornerstone of query analyses performed in accordance with a number of embodiments of the invention, providing means to estimate the storage access costs of given queries. Estimation of storage access costs can enable informed decision-making in routing, with specific instances including but not limited to: Index-Reliant Query Plans: Queries that exclusively utilize indexes can be efficiently identified and routed accordingly; and Complex Join Queries with Limits: For intricate Join queries incorporating Limit clauses, histogram-based distributions can be used to estimate the approximate number of rows required to attain desired outputs.

Systems and methods in accordance with some embodiments of the invention may focus predominantly on storage access costs, while other scaling concerns including but not limited to CPU and memory can be addressed through replication-based scaling (e.g., across multiple servers). This deliberate focus may simplify query router analysis, yielding more accurate routing decisions. By optimizing routing decisions for the storage aspect of costly plans, systems can leverage the strengths of both RDBMS and data warehouses.

### A. Automated Query Routing

Systems and methods in accordance with multiple embodiments of the invention may utilize software including but not limited to PostgreSQL in order to enable automatic query routing in tiered databases. In accordance with various embodiments of the invention, the routing of queries may be determined in accordance with estimates of storage access cost.

Methods in accordance with certain embodiments of the invention may enable systems to maintain large numbers of materialized views based on comparably small numbers of base tables. In accordance with numerous embodiments, base tables may be configured to be append-only, allowing incoming data to be appended to the storage, while existing data is immutable. In accordance with many embodiments of the invention, materialized views may represent the cached states of complex and/or critical queries on base tables. In accordance with several embodiments of the invention, materialized views may be stored in the relational layer following user request.

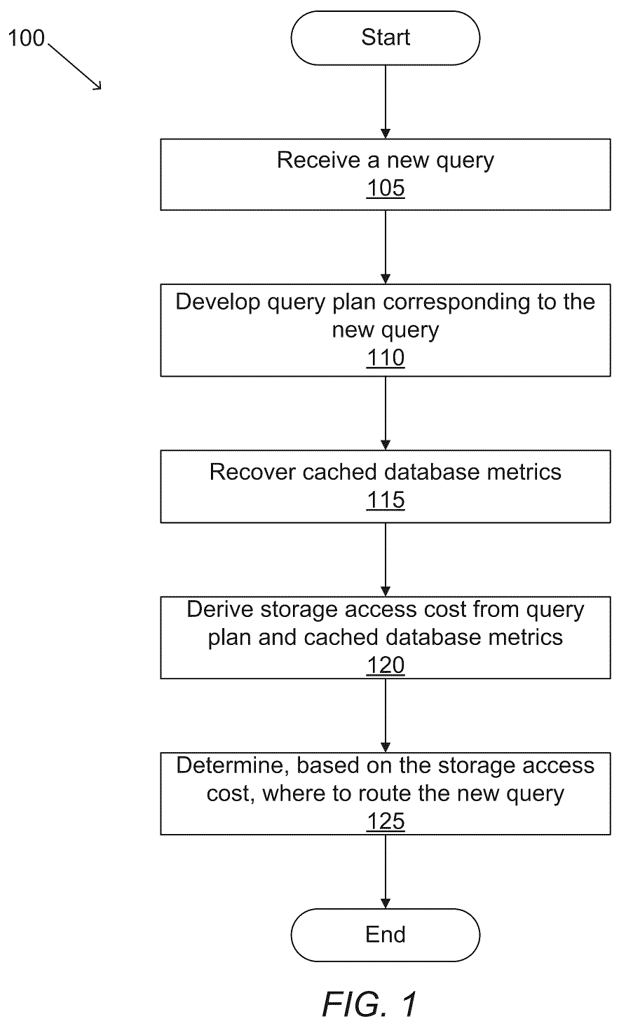

A process for routing database queries in accordance with many embodiments of the invention is illustrated in FIG. 1. Process 100 may be performed in relation to tiered databases. Additionally or alternatively, for tiered databases configured in accordance with several embodiments of the invention, tiers may be distinguishable based on characteristics including but not limited to query processing time. In accordance with certain embodiments, at least one layer of a tiered database may be a real-time database including but not limited to a PostgreSQL relational database. Process 100 receives (105) a new query. Process 100 may be performed by query planners and/or proxy layers. Query planners may be decoupled from the tiers of the tiered databases. In accordance with some embodiments, query planners may be included in proxy layers of the tiered databases. Additionally or alternatively, query planners may run on software including but not limited to PostgreSQL.

Process 100 develops (110) a query plan corresponding to the new query. PostgreSQL can devise a query plan for each query it receives and includes a complex planner that is configured to optimize plans. The structure of PostgreSQL query plan is a tree of plan nodes. Nodes at the bottom level of the tree are scan nodes: they return raw rows from a table. There are different types of scan nodes for different table access methods: sequential scans (as described above), index scans (that scan for entries according to indices), and bitmap index scans (that first scan the index and compile a subset of the table, needed at the end of the scan according to indices in the query, allowing PostgreSQL to actually fetch the entries from the subset). There are also non-table row sources, such as VALUES clauses and set-returning functions which have their own scan node types. If the query requires joining, aggregation, sorting, or other operations on the raw rows, then there will be additional nodes above the scan nodes to perform these operations.

The query plan may include, but is not limited to storage access steps. In accordance with various embodiments of the invention, the query plan may govern default actions performed prior to responding to a query. As indicated above, query plans configured in accordance with various embodiments of the invention may be represented as trees of nodes.

Process 100 recovers (115) cached database metrics. In accordance with many embodiments of the invention, database metrics may be cached after being determined in real time, determined over pre-set durations, and/or determined in response to user request. In accordance with multiple embodiments of the invention, cached database metrics may be recovered directly from relational (e.g., Postgres) and/or data warehouse (e.g., Delta Lake) layers. For example, in Delta Lake, the metadata for each Delta table can be stored alongside the physical table data. Meanwhile, in Postgres, system catalogs may be the place where the relational database management system stores schema metadata, such as information about tables and columns, and internal bookkeeping information. Additionally or alternatively, database metrics may be aggregated from one or both layers and stored in record caching implemented on the proxy layer. Tiered databases configured in accordance with many embodiments of the invention may utilize, but are not limited to Apache Kafka in-memory caching configurations.

Apache Kafka may use programs and/or Kafka stream libraries (stream processing applications) for internal caching, wherein the computational logic can be defined through graphs (topologies) of nodes and edges. The nodes (stream processors) represent processing steps to transform data before the records are stored and/or forwarded downstream to other nodes. In implementing memory management, Apache Kafka can (additionally) allow users to specify the total memory (i.e., RAM) size used for internal caching and compacting of records.

Moreover, specifying the total RAM size of record caches, Apache Kafka's processor API allows records to be written from processor nodes to state stores. State stores are data structures that can be used to store recently received input records, to track rolling aggregates, to de-duplicate input records, to query records, etc. Further, state stores can be interactively queried from other applications, including but not limited to those described above. Using Apache Kafka, state stores can allow internal caching and compacting of output records before storage in the state stores.

Internal caching is done by receiving individual input records (e.g., entries in the form of key-value pairs) from upstream nodes, applying operations to the input records, and/or producing one or more output records to its downstream processors using the graph edges (streams). In the context of these topologies, the streams may operate as ordered, replayable, and fault-tolerant sequences of immutable data records.

Record caching can be enabled/disabled through specific function calls and, further, the record caches in the Processor API do not need to cache (or compact) any output records that are being forwarded (to downstream nodes and/or state stores). This means that all downstream processor nodes can see all records, whereas the state stores see a reduced number of records. For example, with the Processor API systems can store records in state stores while forwarding different values downstream allowing performance optimization for the state stores.

Process 100 derives (120) a storage access cost from the query plan and the cached database metrics. In accordance with many embodiments of the invention, storage access costs (SACs) may be derived in terms of estimated time (and/or processing requirement) needed to respond to the query. SACs may be based on various costs associated with responding to queries, including but not limited to reading raw data, reading index data, communication costs, and/or CPU execution time. Additionally or alternatively, SACs may depend on the startup costs and/or total costs taken from the query plan(s). In accordance with numerous embodiments of the invention, the SACs may be derived based on independent Application Programming Interfaces (APIs). In accordance with some embodiments of the invention, startup costs may be determined by the respective frameworks of the constituent layers (e.g., PostgreSQL for the relational layer; Delta Lake for the data warehouse layer). In such cases, the respective storage access costs may follow utilize different standards and/or units. In such cases, process 100 may include a conversion step to enable evaluation of storage access costs by uniform metrics.

Process 100 determines (125), based on the storage access cost, where to route the new query. In instances where a tiered database includes a real-time database layer (e.g., PostgreSQL relational databases) and a (historical) data warehouse layer, routing the new query may account for the distinct benefits of each layer. In such cases, when the SAC exceeds a predetermined threshold, the query may be routed to the data warehouse layer. This accounts for the fact that a greater SAC may correspond to a greater need for data; as a result, the greater throughput of the data warehouse may be put to better use. Additionally or alternatively, when the SAC does not exceed the predetermined threshold, the query may be routed to the relational database layer. This accounts for the fact that a lower SAC may take more advantage of the lower latency of relational database layers. In accordance with multiple embodiments of the invention, when the tiered database includes a relational database layer, the determination of where to route the new query may be made independently of whether the relational database layer is capable of responding to the query. In such cases, the deciding factor for routing may nevertheless still be the derived SAC.

While a specific process for routing database queries is described above, any of a variety of processes can be utilized to generate models as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce processing times/costs. In some embodiments, one or more of the above steps may be omitted.

### B. Tiered Database Configurations

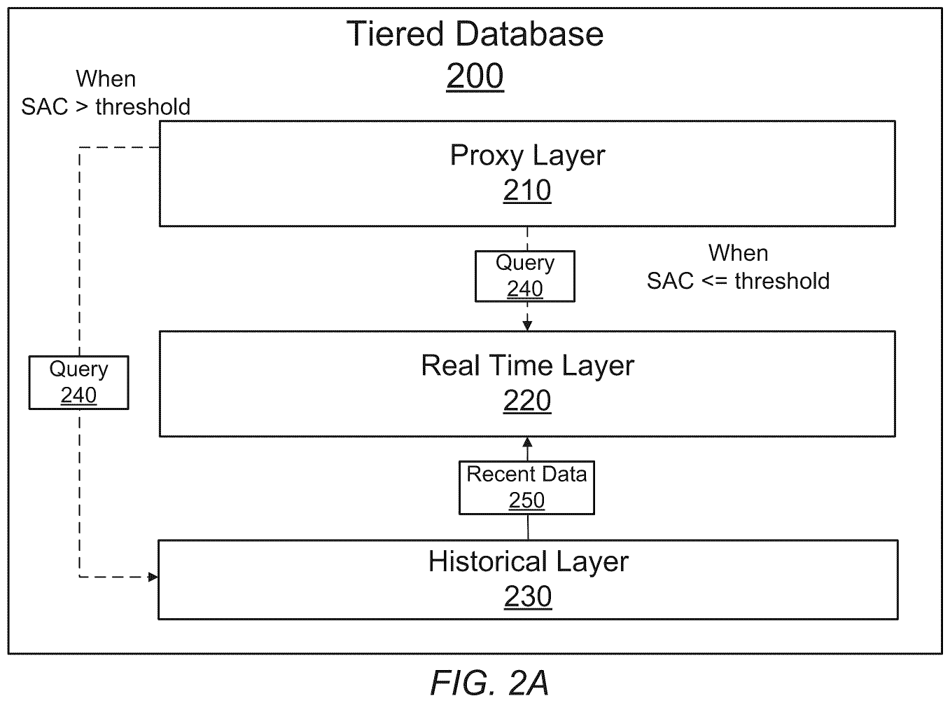

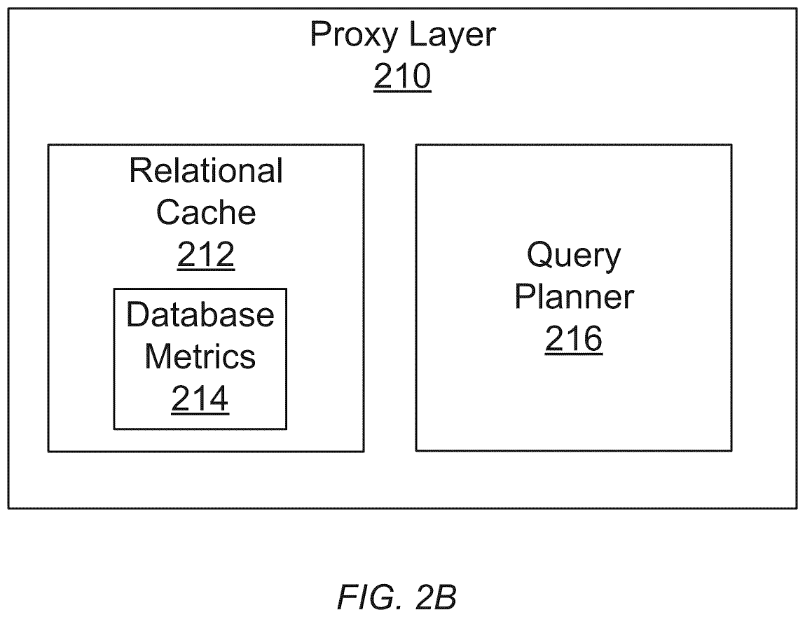

A tiered database configured in accordance with numerous embodiments of the invention is illustrated in FIGS. 2A-2B. Tiered databases configured in accordance with several embodiments of the invention may incorporate a plurality of layers including but not limited to: a proxy layer 210 directed to the processing and routing of new queries; a relational database layer 220 (also referred to as a relational layer in this disclosure) optimized for storing data that is accessed and/or modified frequently (i.e., a hot tier); and a data warehouse 230 optimized for storing data that is infrequently accessed or modified.

In the example in FIG. 2A, the query 240 is routed to the data warehouse 230 when the SAC exceeds a predetermined threshold, and routed to the relational database layer 220 when the SAC does not. Data warehouses 230 configured in accordance with numerous embodiments of the invention may follow Lakehouse configurations (hybrid data architectures that combine aspects of the data warehouse structure with aspects of the data lake structure).

Relational layers 220 configured in accordance with some embodiments of the invention may be implemented using Postgres systems. Additionally or alternatively, relational layers 220 may differ from data warehouse 230 layers by virtue of the relational layers 220 having significantly less storage capacity. As such, in accordance with multiple embodiments, Postgres may be implemented to allow relational layers 220 to reflect the state of the data warehouse up to a specific point in the past. Additionally or alternatively, relational layers 220 may be regularly updated in order to specifically store recent data 250 obtained from the data warehouse 230 over a recent period of recency. For example, Delta Lake time travel allows for queries of older snapshots of Delta tables. This can be applied for use cases including: re-creating analyses, reports, and/or outputs (for example, the output of a machine learning model); writing complex temporal queries; fixing mistakes in data; and/or providing snapshot isolation for sets of queries for fast changing tables.

Relational layers 220 of tiered databases configured in accordance with many embodiments of the invention may have periods of varying durations for recent data 250 stored, including but not limited to one month, one week, one day, and one hour.

A proxy layer configuration in accordance with many embodiments of the invention is illustrated in FIG. 2B. In addition to query routing, proxy layers 210 may be used to store the database metrics and/or produce query plans. As such, proxy layers 210 configured in accordance with some embodiments of the invention may include but are not limited to: a collection of relational metadata 212 that stores database metrics 214 for the tiered database; and the query planner 216 that directly produces the query plan(s) and performs routing as disclosed in FIG. 1. Within the relational metadata 212, potential database metrics 214, for the tiered database and/or particular layers, may include but are not limited to metadata metrics, schema details, table statistics (e.g., table row count, table width), index statistics (e.g., distribution of index values), and/or system statistics (e.g., processing power estimation, storage latency of the layers).

Database configurations in accordance with various embodiments of the invention are not limited to use within Postgres and systems. Although database architectures are illustrated in FIGS. 2A-2B, any of a variety of architectures configured to store large data sets and route database queries in accordance with many embodiments of the invention can also be utilized.

### C. Systems for Facilitation of Tiered Databases

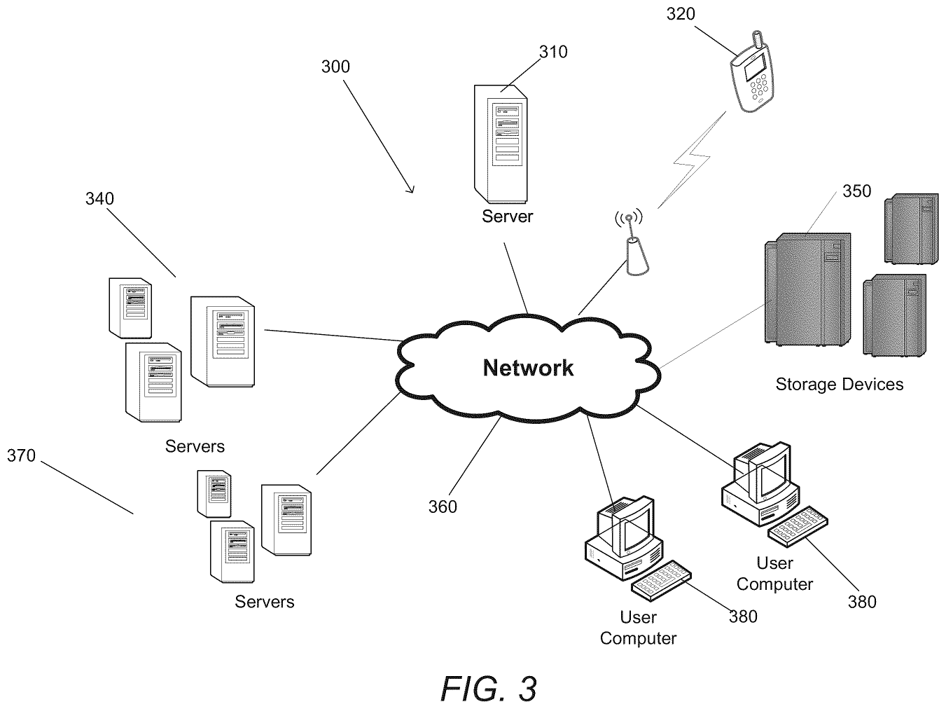

An example of a database management system that may be used for facilitation of tiered databases configured in accordance with some embodiments of the invention is illustrated in FIG. 3. The database management system 300 includes storage devices 350 that can be used to store raw data including but not limited to business data. The storage devices 350 can communicate with server systems 310, 340, and 370 via a communications network 360. The communications network 360 is a network such as the Internet that allows devices connected to the network 360 to communicate with other connected devices.

Server systems 310, 340, and 370 are connected to the network 360. Server systems 310, 340, and 370 may be configured to run software including but not limited to PostgreSQL and/or Delta Lake. Each of the server systems 310, 340, and 370 is a group of one or more servers communicatively connected to one another via internal networks that execute processes that provide cloud services to users over the network 360. One skilled in the art will recognize that the management system may exclude certain components and/or include other components that are omitted for brevity without departing from this invention.

For purposes of this discussion, cloud services are one or more applications that are executed by one or more server systems to provide data and/or executable applications to devices over a network. The server systems 310, 340, and 370 are shown each having three servers in the internal network. However, the server systems 310, 340 and 370 may include any number of servers and any additional number of server systems may be connected to the network 360 to provide cloud services. In accordance with various embodiments of this invention, database management systems that use methods for routing queries in accordance with an embodiment of the invention may utilize processes executed on a single server system and/or a group of server systems communicating over network 360.

Users may use personal devices 380 and 320 that connect to the network 360 to perform processes including but not limited to making queries and/or displaying database views in accordance with various embodiments of the invention. In accordance with some embodiments, user interface on personal devices 380 may enable users to remain uninformed of the different layers of tiered databases. In doing so, the different layers of the tiered database may be configured to enable synchronization. Additionally or alternatively, synchronization may be enabled through aggressive tiering systems. In the shown embodiment, the personal devices 380 are shown as desktop computers that are connected via a conventional “wired” connection to the network 360. However, the personal device 380 may be a desktop computer, a laptop computer, a smart television, an entertainment gaming console, or any other device that connects to the network 360 via a “wired” connection. The mobile device 320 connects to network 360 using a wireless connection. A wireless connection is a connection that uses Radio Frequency (RF) signals, Infrared signals, or any other form of wireless signaling to connect to the network 360. In the example of this figure, the mobile device 320 is a mobile telephone. However, mobile device 320 may be a mobile phone, Personal Digital Assistant (PDA), a tablet, a smartphone, or any other type of device that connects to network 360 via wireless connection without departing from this invention.

As can readily be appreciated the specific computing system used for data storage performed in accordance with certain embodiments of the invention is largely dependent upon the requirements of a given application and should not be considered as limited to any specific computing system(s) implementation.

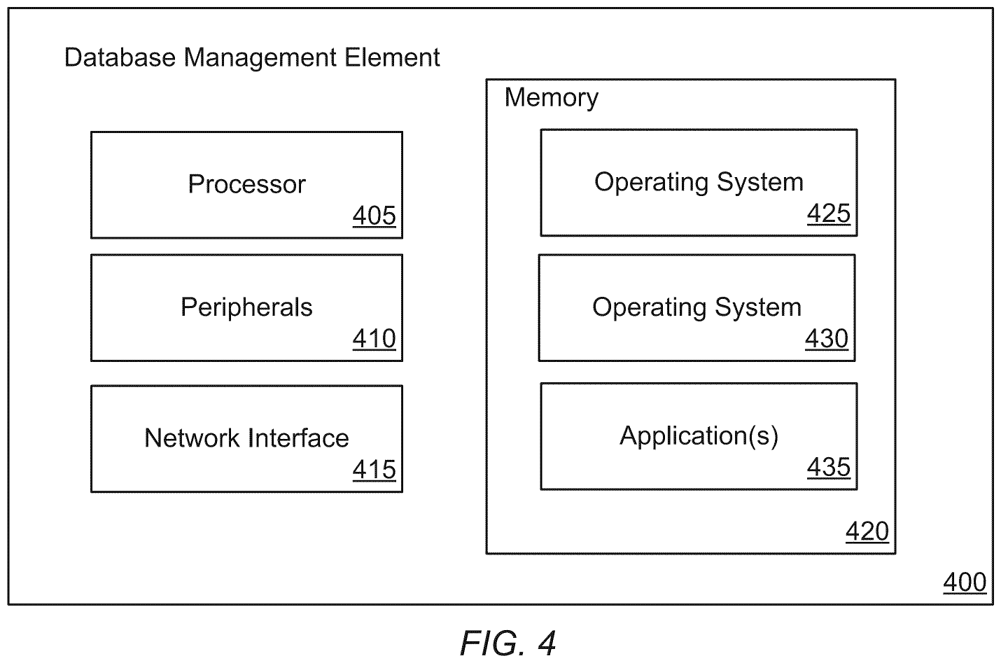

An example of a database management element that executes instructions to perform processes that route queries in accordance with some embodiments of the invention is illustrated in FIG. 4. Database management elements in accordance with many embodiments of the invention can include (but are not limited to) one or more of mobile devices, and/or computers. The database management element 400 of FIG. 4 includes a processor 405, peripherals 410, a network interface 415, and a memory 420. One skilled in the art will recognize that database management elements may exclude certain components and/or include other components that are omitted for brevity without departing from this invention.

The processor(s) 405 can include (but is not limited to) a processor, microprocessor, controller, or a combination of processors, microprocessor, and/or controllers that performs instructions stored in the memory 420 to manipulate data stored in the memory. Processor instructions can configure the processor 405 to perform processes in accordance with certain embodiments of the invention. In various embodiments, processor instructions can be stored on a non-transitory computer-readable medium.

Peripherals 410 can include any of a variety of components for capturing data, such as (but not limited to) displays, entry devices, and/or sensors. In a variety of embodiments, peripherals can be used to gather inputs and/or provide outputs. Database management elements 400 can utilize network interface 415 to transmit and receive data over a network based upon the instructions performed by processor(s) 405. Peripherals and/or network interfaces in accordance with many embodiments of the invention can be used to gather inputs that can be used to add, remove, and/or modify database entries.

Systems implemented in accordance with many embodiments of the invention can utilize network interface 415 and/or memory 420 to transmit data, over a network based upon the instructions performed by processor(s) 405, receive that data, and/or store that data. Network interfaces in accordance with many embodiments of the invention can be used to gather inputs (e.g., database entries 430) that can be used to implement database construction configured in accordance with certain embodiments of the invention. Memory 420, as configured in accordance with some embodiments of the invention may include an operating system 425, and/or application(s) 435 that can be used to implement processes performed in accordance with several embodiments of the invention.

As can readily be appreciated, the database management system is largely dependent upon the requirements of a given application and should not be considered as limited to any specific computing system(s) implementation. Although specific database configurations are discussed above, many different methods of routing queries can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A tiered database, comprising:
a data warehouse that is configured to store obtained data;
a relational layer, wherein:
the relational layer stores a copy of a subset of the obtained data; and
the subset of the obtained data comprises entries stored in the data warehouse within a certain period of recency; and
a proxy layer, comprising:
a collection of relational metadata comprising a set of database metrics for a tiered database, wherein the set of database metrics is derived from the obtained data; and
a query planner, wherein the query planner is configured to:
receive, from a sender, a database query corresponding to the obtained data;
determine a preliminary query plan to respond to the database query;
recover, from the collection of relational metadata, the set of database metrics;
compute, from the set of database metrics and the preliminary query plan, a storage access cost, wherein the storage access cost comprises an estimate for time required to respond to the database query;
route the database query based on the storage access cost, wherein:
the database query is routed to the data warehouse when the storage access cost exceeds a predetermined threshold; and
the database query is routed to the relational layer when the storage access cost does not exceed the predetermined threshold;
receive a result to the database query from at least one of the data warehouse or the relational layer; and
return the result to the database query to the sender.

2. The tiered database of claim 1, wherein the data warehouse comprises:
a lakehouse architecture, wherein the lakehouse architecture accesses a data storage entity for unstructured data, processes the unstructured data, and stores the processed data in the data warehouse;
at least one data manipulation language (DML) operation; and
a slowly changing dimension (SCD), wherein the SCD maintains entries to the data warehouse, updates the entries, and tracks frequencies of updates for the entries.

3. The tiered database of claim 1, wherein:
the set of database metrics comprises:
a first set of database metrics corresponding to the data warehouse; and
a second set of database metrics corresponding to the relational layer; and
computing, from the set of database metrics and the preliminary query plan, the storage access cost, comprises:
computing a first storage access cost from the first set of database metrics and the preliminary query plan, wherein the first cost is in a first unit of measurement;
computing a second cost from the second set of database metrics and the preliminary query plan, wherein the second cost is in a second unit of measurement; and
converting the first and second costs into the storage access cost, wherein the storage access cost is in a third unit of measurement.

4. The tiered database of claim 1, wherein:
the preliminary query plan follows a tree graph structure comprising a plurality of nodes;
each node of the plurality of nodes corresponds to a SQL operation; and
nodes at a bottom level of the tree graph structure are configured to return raw rows from the subset of the obtained data.

5. The tiered database of claim 4, wherein:
the result to the database query comprises a materialized view; and
the query planner is further configured to store the result to the database query in the relational layer.

6. The tiered database of claim 1, wherein a database metric of the set of database metrics is:
selected from the group consisting of: a metadata metric, a schema detail, a table statistic, an index statistic, and a system statistic;
obtained from an external database ingestor, wherein the external database ingestor utilizes a tree graph structure for computational logic; and
cached on the proxy layer, wherein the set of database metrics is updated on the proxy layer at a set duration.

7. A method for operating a query planner, the method comprising:
receiving, from a sender, a database query made to a tiered database, wherein:
the tiered database comprises a data warehouse, a proxy layer, and a relational layer; and
the database query corresponds to obtained data stored in the data warehouse;
determining a preliminary query plan to respond to the database query;
recovering, from a collection of relational metadata stored in the proxy layer, a set of database metrics, for the tiered database, derived from the obtained data;
computing, from the set of database metrics and the preliminary query plan, a storage access cost, wherein the storage access cost comprises an estimate for time required to respond to the database query;
routing the database query based on the storage access cost, wherein:
the database query is routed to the data warehouse when the storage access cost exceeds a predetermined threshold; and
the database query is routed to the relational layer when the storage access cost does not exceed the predetermined threshold, where:
the relational layer stores a copy of a subset of the obtained data; and
the subset of the obtained data comprises entries stored in the data warehouse within a certain period of recency;
receiving a result to the database query from at least one of the data warehouse or the relational layer; and
returning the result to the database query to the sender.

8. The method of claim 7, wherein the data warehouse comprises:
a lakehouse architecture, wherein the lakehouse architecture accesses a data storage entity for unstructured data, processes the unstructured data, and stores the processed data in the data warehouse;
at least one data manipulation language (DML) operation; and
a slowly changing dimension (SCD), wherein the SCD maintains entries to the data warehouse, updates the entries, and tracks frequencies of updates for the entries.

9. The method of claim 7, wherein:
the set of database metrics comprises:
a first set of database metrics corresponding to the data warehouse; and
a second set of database metrics corresponding to the relational layer; and
computing, from the set of database metrics and the preliminary query plan, the storage access cost, comprises:
computing a first storage access cost from the first set of database metrics and the preliminary query plan, wherein the first cost is in a first unit of measurement;
computing a second cost from the second set of database metrics and the preliminary query plan, wherein the second cost is in a second unit of measurement; and
converting the first and second costs into the storage access cost, wherein the storage access cost is in a third unit of measurement.

10. The method of claim 7, wherein:
the preliminary query plan follows a tree graph structure comprising a plurality of nodes;
each node of the plurality of nodes corresponds to a SQL operation; and
nodes at a bottom level of the tree graph structure are configured to return raw rows from the subset of the obtained data.

11. The method of claim 10, wherein:
the result to the database query comprises a materialized view; and
the method further comprises storing the result to the database query in the relational layer.

12. The method of claim 7, wherein a database metric of the set of database metrics is:
selected from the group consisting of: a metadata metric, a schema detail, a table statistic, an index statistic, and a system statistic;
obtained from an external database ingestor, wherein the external database ingestor utilizes a tree graph structure for computational logic; and
cached on the proxy layer, wherein the set of database metrics is updated on the proxy layer at a set duration.

13. A non-transitory computer-readable medium comprising instructions that, when executed, are configured to cause a processor to perform a process for query planning, the process comprising:
receiving, from a sender, a database query made to a tiered database, wherein:
the tiered database comprises a data warehouse, a proxy layer, and a relational layer; and
the database query corresponds to obtained data stored in the data warehouse;
determining a preliminary query plan to respond to the database query;
recovering, from a collection of relational metadata stored in the proxy layer, a set of database metrics, for the tiered database, derived from the obtained data;
computing, from the set of database metrics and the preliminary query plan, a storage access cost, wherein the storage access cost comprises an estimate for time required to respond to the database query;
routing the database query based on the storage access cost, wherein:
the database query is routed to the data warehouse when the storage access cost exceeds a predetermined threshold; and
the database query is routed to the relational layer when the storage access cost does not exceed the predetermined threshold, where:
the relational layer stores a copy of a subset of the obtained data; and
the subset of the obtained data comprises entries stored in the data warehouse within a certain period of recency;
receiving a result to the database query from at least one of the data warehouse or the relational layer; and
returning the result to the database query to the sender.

14. The non-transitory computer-readable medium of claim 13, wherein the data warehouse comprises:
a lakehouse architecture, wherein the lakehouse architecture accesses a data storage entity for unstructured data, processes the unstructured data, and stores the processed data in the data warehouse;
at least one data manipulation language (DML) operation; and
a slowly changing dimension (SCD), wherein the SCD maintains entries to the data warehouse, updates the entries, and tracks frequencies of updates for the entries.

15. The non-transitory computer-readable medium of claim 13, wherein:
the set of database metrics comprises:
a first set of database metrics corresponding to the data warehouse; and
a second set of database metrics corresponding to the relational layer; and
computing, from the set of database metrics and the preliminary query plan, the storage access cost, comprises:
computing a first storage access cost from the first set of database metrics and the preliminary query plan, wherein the first cost is in a first unit of measurement;
computing a second cost from the second set of database metrics and the preliminary query plan, wherein the second cost is in a second unit of measurement; and
converting the first and second costs into the storage access cost, wherein the storage access cost is in a third unit of measurement.

16. The non-transitory computer-readable medium of claim 13, wherein:
the preliminary query plan follows a tree graph structure comprising a plurality of nodes;
each node of the plurality of nodes corresponds to a SQL operation; and
nodes at a bottom level of the tree graph structure are configured to return raw rows from the subset of the obtained data.

17. The non-transitory computer-readable medium of claim 16, wherein:
the result to the database query comprises a materialized view; and
the process further comprises storing the result to the database query in the relational layer.

18. The non-transitory computer-readable medium of claim 13, wherein a database metric of the set of database metrics is:
selected from the group consisting of: a metadata metric, a schema detail, a table statistic, an index statistic, and a system statistic;
obtained from an external database ingestor, wherein the external database ingestor utilizes a tree graph structure for computational logic; and
cached on the proxy layer, wherein the set of database metrics is updated on the proxy layer at a set duration.
